(19) United States
(12) Patent Application Publication
(10) Pub. No.: US 2004/0124632 A1
(43) Pub. Date: Jul. 1, 2004

(54) T pipe for connecting a reduced branch pipe to a main pipe and a method for producing such a t pipe

(76) Inventor: Matti Jokinen, Maxmo (FI)

Correspondence Address: CONNOLLY BOVE LODGE & HUTZ LLP, SUITE 800, 1990 M STREET NW, WASHINGTON, DC, 20036-3425, US

(21) Appl. No.: 10/474,305

(22) PCT Filed: Mar. 11, 2002
(86) PCT No.: PCT/FI02/00189

(30) Foreign Application Priority Data
Apr. 9, 2001 (SE) 20010732

(51) Int. Cl. F16L 39/00; B29C 65/02; B29C 65/14

(52) U.S. Cl. 285/133.11; 156/256; 156/257; 156/273.3; 156/304.2; 156/304.3; 285/197

(57) ABSTRACT

The present invention relates to a T pipe for connecting a reduced branch pipe to a main pipe and to a method for producing such a pipe. The invention is characterized in that said T pipe comprises a thermoplastic connection piece (1) including a connection (2) for the branch pipe as well as a base part (3) essentially matching with the curvature of the main pipe and being essentially rectangular viewed in the direction of the central axis of said connection (2), said base part being butt welded to a pipe ring (4) having a size similar to that of the main pipe and a width similar to that of the base part (3), instead of a piece removed from said ring pipe and having a size similar to that of the base part (3).

This invention relates to a thermoplastic T pipe for connecting a reduced branch pipe to a main pipe. The invention relates also to a method for producing such a T pipe.

At present, there is no reasonable method in use for the manufacture of especially large-sized, reduced branched pipes. For pipes of a certain size, it is possible to produce a welding mirror, and for small-sized pipes there are flexible saddles suitable for some sizes of main pipes, but there is no method enabling the same connection piece to be applied to main pipes of different sizes and different pressure categories.

An object of the present application is to provide such a T pipe which can be produced easily irrespective of the size and the thickness of the main pipe. This object can be achieved by a T pipe which is characterized in that it comprises a thermoplastic connection piece including a connection for a branch pipe, as well as a base part essentially matching with the curvature of the main pipe and being essentially rectangular, viewed in the direction of the central axis of said connection, which base part is butt welded to a pipe ring having a size similar to that of the main pipe and a width similar to that of the base part, instead of a piece removed from said pipe ring and having a size similar to that of the base part. Said T pipe can be butt welded to a desired position of the main pipe, either as such, or it can be provided with extension pieces or collars, both at the ends of the pipe ring and at the connection for the branch pipe so that a common butt welding equipment can be used for installing said T pipe, or so that the installing can be carried out as flange mounting.

Due to the wall thickness of the connection piece, a connection piece designed for a branch pipe of a certain size can be used in the T pipe according to the invention for main pipes of various sizes.

According to the invention, a method for forming the above mentioned T pipe comprises the following steps:

producing a thermoplastic connection piece having a connection for a branch pipe and a base part essentially matching with the curvature of a main pipe and being essentially rectangular, viewed in the direction of the central axis of said connection;

cutting a pipe ring having a width corresponding to an axial extension of the base part of the connection piece from a thermoplastic pipe having a size similar to that of the main pipe,

fixing said pipe ring to a welding table or bracket;

cutting from the pipe ring a piece corresponding to the dimensions of the base part;

finishing for butt welding the surfaces to be welded together of the cut pipe ring and the base part of the connection piece:

heating the finished surfaces to be welded to a plastic state by means of a welding mirror or mirrors,

removing the welding mirror or mirrors and pressing together the surfaces to be joined to provide a butt welded joint between the pipe ring and the base part of the connection piece.

In order to be able to connect said T pipe to a pipe system by a common butt welding equipment or by flange fastening, the T pipe can be finished by butt welding either a pipe piece or a collar to the ends of the T pipe both for the main pipe and for the branch pipe.

Further features of the invention are disclosed in the enclosed dependent claims.

In the following the invention is discribed in more detail with reference to the accompanying drawings in which

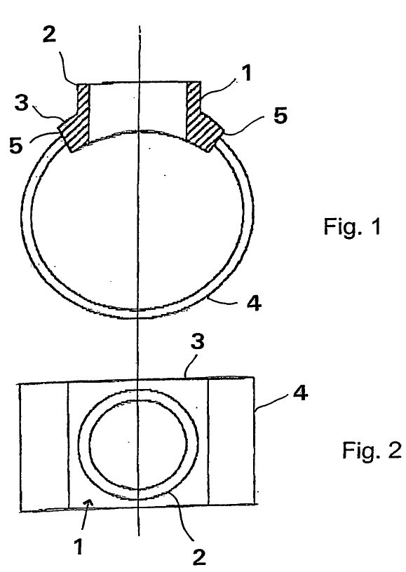

FIG. 1 shows a cross section of a first embodiment of a T pipe according to the invention,

FIG. 2 shows a top view of the T pipe of FIG. 1,

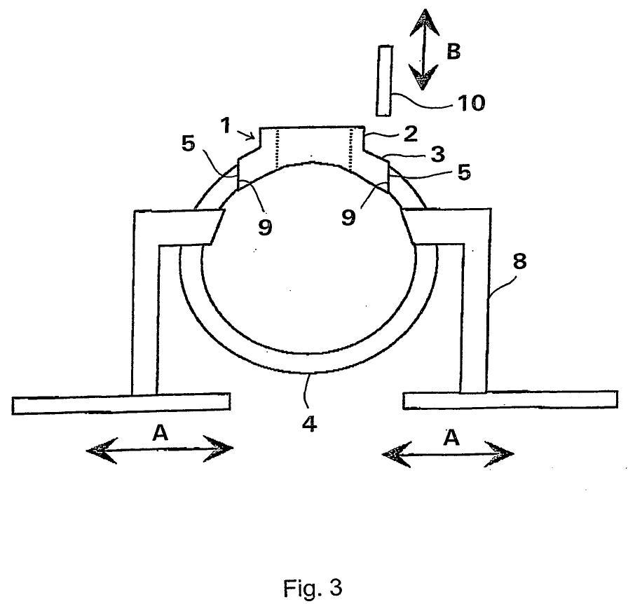

FIG. 3 shows a further embodiment of the T pipe according to the invention, fixed to a welding table, after a pipe ring has been cut open and a connection piece has been mounted;

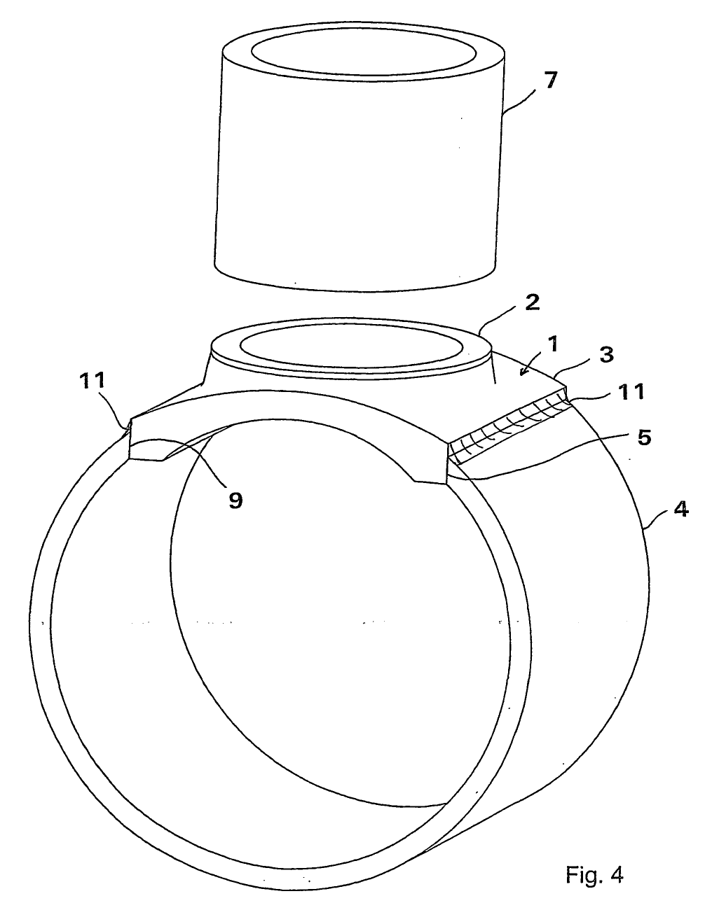

FIG. 4 shows a pespective view of the T pipe of FIG. 3 in a greater scale,

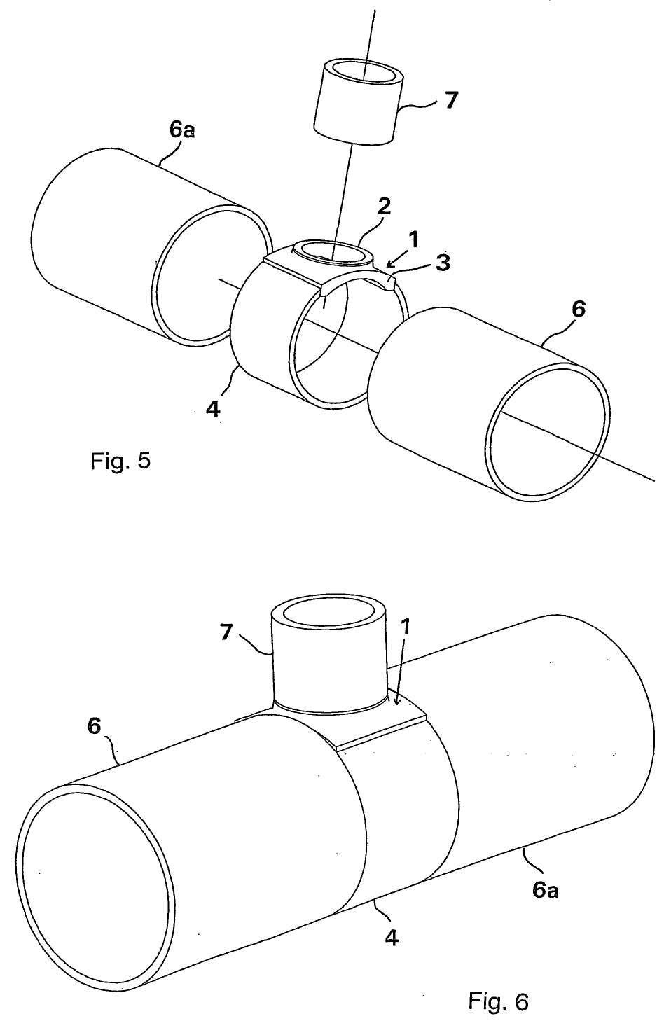

FIG. 5 shows a pespective view of an example for finishing the T pipe of FIG. 4 and

FIG. 6 shows the T pipe finnished in the manner shown in FIG. 5.

A T pipe according to the invention for connecting a reduced branch pipe to a main pipe comprises a thermoplastic connection piece 1 including a connection 2 for the branch pipe, as well as a base part 3 essentially matching with the curvature of the main pipe and being essentially rectangular, viewed in the direction of the central axis of said connections 2, which base part is butt welded to a pipe ring 4 having a size similar to that of the main pipe and a width similar to that of the base part 3, instead of a piece removed from said pipe ring and having a size similar to that of the base part 3.

The connection piece 1 shown in FIGS. 1 and 2 has been manufactured according to the first embodiment with a base part 3, having limiting surfaces 5 in the axial direction of the of the main pipe, extending in planes along radius of the curvature of the base part 3. When the T pipe includes such a connection piece 1, also the piece having a size of the base part 3 is removed from the pipe ring 4 of said T pipe by radial cuts.

According to a further embodiment, shown in FIGS. 3 to 6, the limiting surfaces 5 of the base part 3 of the connection piece 1, in the axial direction of the main pipe, are parallel to each other and extend in planes parallel to the central axis of the connection 2 of said connection piece. Thereby the limiting surfaces 5 have larger areals enabling a more stable weld joint between the base part 3 and a pipe ring 4, because the pipe ring 4 has been cut with the same bevel. A further significant advantage of this embodiment lies in the fact that both weld joints can be performed simultaneously, because said surfaces to be joined will be positioned completely perpendicularly against the forces pressing them against each other in the butt welding stage.

In order to be able to mount the above described T pipe to a pipe system by a common butt welding equipment, both ends of the pipe ring 4 in the T pipe are preferably provided with extension pieces 6, 6a having a size similar to that of the main pipe, and the connection 2 for the branch pipe in said T pipe is provided with an extension piece 7 having a size similar to that of the branch pipe as shown as an exemple in FIG. 6. If said T pipe is intended to be attached to a pipe system by a flange mounting, said ends and the connection 2 can suitable be provided with collars of corresponding sizes.

According to the invention, the production of the T pipe comprises the following steps:

a thermoplastic connection piece 1 is preproduced by using a moulding or casting technique, said connection piece including a connection 2 for a branch pipe of a certain size as well as a base part 3 essentially matching with the curvature of the main pipe and being essentially rectangular viewed in the direction of the central axis of said connection 2, form;

a pipe ring 4 having a width corresponding to the axial extension of the base part 3 of the connection piece, is cut from a thermoplastic pipe having a size of the main pipe to be built;

the so cut pipe ring 4 is fixed to a welding table 8 or bracket having clamping means movable in the direction of double arrows A to adapt the welding table for pipes of different sizes as well as to direct pressing and tensile forces to the fixed pipe ring 4;

a piece corresponding to the dimensions of the base part 3 of the connection piece is then cut from the restrained pipe ring 4;

the surfaces 5, 9 of the pipe ring 4 cut open and the base part 3, which are to be welded together, are finished for butt welding,

the finished surface pairs 5, 9, to be welded together, are heated to a plastic state by means of a welding mirror 10 or mirrors which are to be inserted between each of the surface pairs 5, 9, whereby the movement of said welding mirror 10 between a heating position and a rest position is shown schematically by double arrow B;

when the thermoplastic material on the surfaces 5, 9, to be welded together, has reached a plastic state, the welding mirror 10 or mirrors are removed from the space between said surfaces and transferred to the rest position shown in FIG. 3, whereafter the surfaces 5, 9 to be joined are pressed together by pushing the clamping means of the welding table 8 controllably towards each other so to form a butt welded joint between the pipe ring 4 and the base part 3 of the connection piece.

Depending on the shape of the base part 3 of the connection piece, the pipe ring 4 is cut open either by radial cuts as shown in FIGS. 1 and 2, or by cuts extending in the direction of the central axis of the connection 2 of the connection piece, i.e. in principle by vertical cuts as shown in FIGS. 3 to 6 while the pipe ring 4 is fixed to the welding table 8.

According to a first embodiment, the butt welding can be carried out by at first providing a welded joint on one side and thereafter a welded joint on the other side. Hereby it can easily be controlled that a correct pressure force is maintened in the welding zone during the whole period.

According to a second embodiment, both welded joints are carried out simultaneously, especially if all surfaces 5, 9 to be joined are parallel to each other, in which case of course two welding mirrors 10 are needed.

To ensure that the T pipe according to the invention can be installed into a pipe system by a common butt welding equipment, extension pieces 6, 6a having a size similar to that of the main pipe can be butt welded to both ends of the pipe ring 4 and an extension piece 7 having a size similar to that of the branch pipe can be butt welded to the connection 2 for the branch pipe. If, instead of that, the T pipe will be mounted by using a flange mounting, collars of corresponding sizes can be butt welded to said ends of the T pipe.

To ensure that the butt welded joints between the base part 3 and the pipe ring 4 of the connection piece 1 are not damaged or broken due to the loadings directed thereto, said butt welded joints can be reinforced both on the inside and on the outside by a hand extruder as shown schematically in FIG. 4 as to the external reinforcement joint.

1. A T pipe for connecting a reduced branch pipe to a main pipe, characterized: in that it comprises a thermoplastic connection piece (1) including a connection (2) for the branch pipe, as well as a base part (3) essentially matching with the curvature of the main pipe and being essentially rectangular, viewed in the direction of the central axis of said connection (2), said base part being butt welded to a pipe ring (4) having a size similar to that of the main pipe and of a width similar to that of the base part (3), instead of a piece removed from said pipe ring and having a size similar to that of the base part (3).

2. The T pipe according to claim 1, characterized in that limiting surfaces (5) of the base part (3) in the axia direction of the main pipe extend in radial planes.

3. The T pipe according to claim 1, characterized in that limiting surfaces (5) of the base part (3) in the axial direction of the main pipe are parallel to each other and extend in planes parallel to the central axis of the connection (2) of the connection piece.

4. The T pipe according to claim 1, characterized in that both ends of the pipe ring (4) are provided with extension pieces (6, 6a) or collars of the size of the main pipe, and the connection (2) in the connection piece for the branch pipe is provided with an extension piece (7) or a collar of the size of the branch pipe.

5. A method for producing a T pipe for a reduced branch pipe, characterized by the following steps:
producing a thermoplastic connection piece (1) including a connection (2) for a branch pipe as well as a base part (3) essentially matching with the curvature of the main pipe and being essentially rectangular viewed in the direction of the central axis of said connection (2);
cutting a pipe ring (4) having a width corresponding to an axial extension of the base part (3) of the connection piece from a thermoplastic pipe having a size similar to that of the main pipe;
fixing the pipe ring (4) to a welding table (8) or bracket;
cutting from the pipe ring (4) a piece corresponding the dimensions of the base part (3);
finishing for butt welding the surfaces (5, 9) to be welded together of the cut pipe ring (4) and the base part (3) of the connection piece;
heating the finished surfaces (5, 9), to be welded together, to a plastic state by means of a welding mirror (10) or mirrors,
removing the welding mirror (10) or mirrors and pressing together the surfaces (5, 9) to be joined together to provide a butt welded joint between the pipe ring (4) and the base part (3) of the connection piece.

6. The method according to claim 5, characterized in that the pipe ring (4) is cut open by radial cuts corresponding to the forms of the base part (3), or by cuts parallel to the central axis of the connection (2).

7. The method according to claim 6, characterized in that one joint is butt welded at a time.

8. The method according to claim 6, characterized in that both joints are butt welded simultaneously, especially in case the joints are parallel to the central axis of the connection (2).

9. The method according to claim 5, characterized in that an extension piece (6, 6a) or a collar of the size of the main pipe is butt welded to both ends of the pipe ring (4) and an extension piece (7) or a collar of the size of the branch pipe is butt welded to the connection (2) in the connection piece for the branch pipe.

10. The method according to any of claims 5 to 9, characterized in that the welded joints are reinforced both on the inside and on the outside by means of a hand extruder.
